(19) United States
(12) Patent Application Publication
(10) Pub. No.: US 2018/0003846 A1
(43) Pub. Date: Jan. 4, 2018

(54) SYSTEM AND METHODOLOGY FOR REMOVING NOISE ASSOCIATED WITH SONIC LOGGING

(71) Applicant: Schlumberger Technology Corporation, Sugar Land, TX (US)

(72) Inventors: Toshimichi Wago, Tokyo (JP); Toshihiro Kinoshita, Sagamihara-shi (JP); Jahir Pabon, Newton, MA (US); Wataru Izuhara, Tokyo (JP)

(21) Appl. No.: 15/626,199

(22) Filed: Jun. 19, 2017

Related U.S. Application Data
(60) Provisional application No. 62/356,540, filed on Jun. 30, 2016.

(51) Int. Cl. G01V 1/50

(52) U.S. Cl. CPC G01V 1/50; G01V 2210/32

(57) ABSTRACT

A technique facilitates removal of noise from sonic logging signals. The technique may comprise various approaches used alone or in combination to reduce or eliminate noise associated with tool arrival. The technique may comprise an active cancellation approach which optimizes the cancellation effect while having minimal impact on the desired acoustic signals. The techniques also may utilize an asynchronous noise cancellation approach with a calibration transmitter designed to minimize impact on the desired acoustic signals.

### RELATED APPLICATIONS

The present document is based on and claims priority to U.S. Provisional Application Ser. No. 62/356,540, filed Jun. 30, 2016, entitled “System and Methodology for Removing Noise Associated with Sonic Logging” to Toshimichi Wago et al., which is incorporated herein by reference in its entirety.

### BACKGROUND

The following descriptions and examples are not admitted to be prior art by virtue of their inclusion in this section.

Conventional sonic logging tools are composed of transmitters and receivers. Transmitters generate acoustic waves that propagate through fluid, formation, and the logging tool itself prior to the receivers detecting such propagations. The acoustic waves can be used for reservoir characterization, and the acoustic waves of interest are the ones which propagate through the fluid and the formation containing the reservoir. However, the waves that propagate through the tool body (often referred to as a “tool arrival” wave) are undesirable and have relatively large amplitudes and fast propagation speed, thus interfering with the acoustic waves propagating through the well fluid and reservoir. The tool arrival, i.e. the waves that propagate through the tool body, is considered to be noise in the desired signal because it interferes with the information from the surrounding well bore fluid or formation.

Attempts have been made to reduce the effects of this unwanted noise. For example, sonic logging tools used in both wireline and logging while drilling (LWD) applications have been constructed with passive attenuators or isolators. The passive attenuator delays the tool arrival and scatters the acoustic energy between the transmitter and receiver transducers. Consequently, the tool arrival signal arrives at a different time and with a much lower energy than the signal of interest associated with the waves propagating through the fluid and reservoir. However, the passive attenuator tends to be complex, expensive, and of lower structural integrity than other portions of the sonic logging tool. Furthermore, passive attenuators operate at a limited frequency band which makes their operational range limited.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, a system and methodology facilitate removal of noise from sonic logging signals. The system and methodology utilize various techniques, alone or in combination, to reduce or eliminate noise associated with tool arrival. The techniques may comprise an active cancellation approach which uses a cancellation source and simultaneous firing of a main and canceling transmitter and optimizes the cancellation effect while having minimal impact on the desired acoustic signals. The techniques also may utilize an asynchronous noise cancellation approach with signal processing based cancellation and asynchronously firing of a main and canceling transmitter.

Other or alternative features will become apparent from the following description, from the drawings, and from the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is an illustration of an example of a sonic logging system deployed in a borehole and including a main transmitter section and a canceling source, according to an embodiment of the disclosure;

FIG. 2 is a cross-sectional view taken along a center axis of the sonic logging system illustrated in FIG. 1, according to an embodiment of the disclosure;

FIG. 3 is a cross-sectional view of an example of the main transmitter section illustrated in FIG. 1, according to an embodiment of the disclosure;

FIG. 4 is a cross-sectional view of an example of the canceling source illustrated in FIG. 1, according to an embodiment of the disclosure;

FIG. 5 is another view of an example of the canceling source, according to an embodiment of the disclosure;

FIG. 6 is a graphical illustration showing the slowness-time coherence results of testing with respect to the sonic logging system having the main transmitter section and the canceling source, according to an embodiment of the disclosure;

FIG. 7 is a graphical illustration showing test results utilizing an example of asynchronous noise cancellation, according to an embodiment of the disclosure;

FIG. 8 is an illustration of an example of a sonic logging tool which may be used with asynchronous noise cancellation, according to an embodiment of the disclosure;

FIG. 9 is a graphical illustration showing an acoustic signal received at the sonic logging tool without noise cancellation; and

FIG. 10 is a graphical illustration showing an acoustic signal received at the sonic logging tool and submitted to asynchronous noise cancellation, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The present disclosure generally relates to a system and methodology which facilitate removal of noise from sonic logging signals. A sonic logging tool may be deployed into a borehole and used to obtain information regarding subterranean reservoirs and other downhole entities, such as evaluating cement bonding and creating cement bonding logs (i.e., by using casing signal for example). In other cases, the sonic tools may be used to image a surrounding formation. In order to evaluate various downhole entities, an acoustic signal, e.g. a pressure wave, is generated by a transmitter in the sonic logging tool. The wave propagates through the surrounding formation containing the reservoir as well as through fluid, e.g. well fluid in the reservoir and in the borehole. The system and methodology described herein help remove the effects associated with tool arrival, i.e. the noise associated with the acoustic signal/pressure wave as it travels through the tool body of the sonic logging tool without having traveled through the formation.

According to embodiments described herein, the system and methodology utilize various techniques, alone or in combination, to reduce or eliminate noise associated with tool arrival. The techniques may comprise an active noise cancellation approach which uses a cancellation source with simultaneous firing of a main and the cancellation source transmitters, and optimizes the cancellation effect while being implemented to have a minimal impact on the desired acoustic signals. The techniques also may utilize an asynchronous noise cancellation approach using signal processing based cancellation with asynchronous firing of a main and the cancellation or calibration source transmitters.

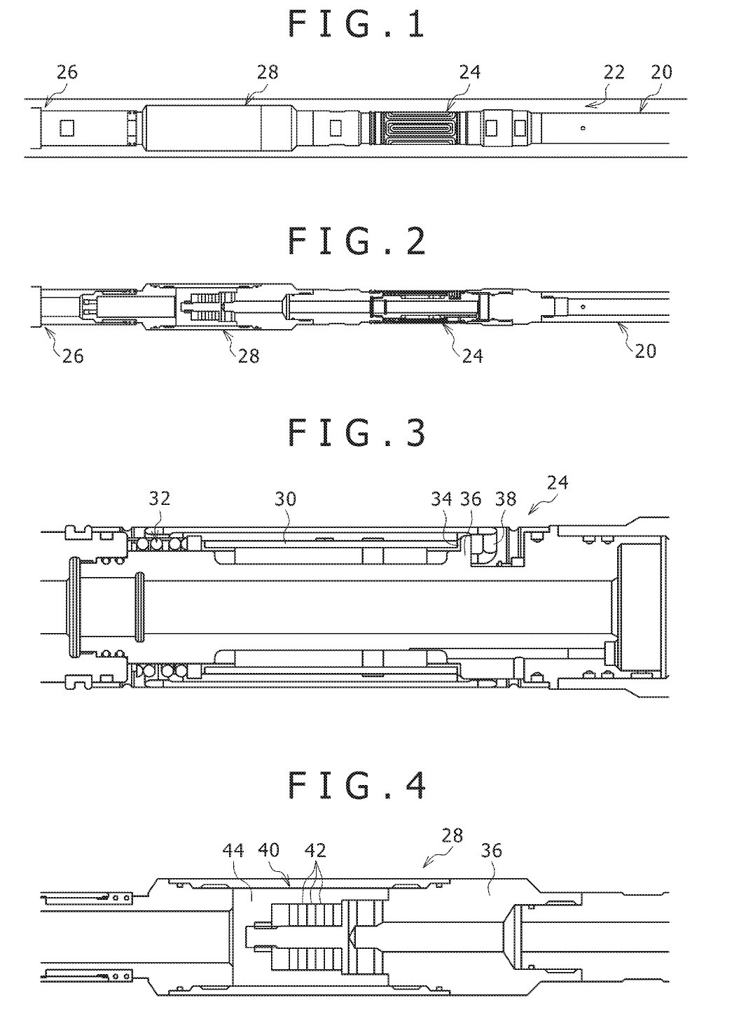

Referring generally to FIGS. 1 and 2, an embodiment of a sonic logging tool 20 is illustrated as deployed in a borehole 22, e.g. a wellbore (see FIG. 1). The sonic logging tool 20 may comprise a variety of components and includes a main transmitter 24, receivers 26, and a canceling source or sources 28. In this embodiment, the main transmitter 24 is optimized to excite the formation and the canceling source(s) 28 is constructed to optimize the noise cancellation effect while having a minimal impact on the formation. This optimization produces minimal undesired effects on the borehole acoustic signals being received by receivers 26 and result in improved data after processing. In this example, the sonic logging tool 20 is able to perform tool arrival active cancellation without negatively affecting the borehole response. In a variety of applications, the sonic logging tool 20 may be deployed downhole into borehole 22, e.g. into a wellbore, and operated to emit and receive acoustic signals so as to gather information regarding the surrounding formation/reservoir and on well fluids in the formation and borehole 22.

With additional reference to FIG. 3, an enlarged sectional illustration of an embodiment of the main transmitter 24 is illustrated. In this example, the main transmitter 24 comprises a piezo component 30, e.g. a cylindrical piezo component, which may be radially polarized. A spring member 32 supports the piezo component 30 in an axial direction, and a soft or compliant material 34, e.g. an elastomeric ring, may be positioned between the piezo component 30 and a body 36 of the sonic logging tool 20.

It should be noted the body 36 may be referred to as a collar. The body 36 experiences a body or collar response to received acoustic signals in the form of acoustic waveforms traveling back to the sonic logging tool 20. In the illustrated example, a borehole coupling module 38, e.g. an oil filled module, may be used to provide an effective coupling between the piezo component 30 and the surrounding borehole 22. The main transmitter 24 shown is only one possible configuration and is shown as an example. Other embodiments of main transmitters 24 can also be composed of arrays of piezo ceramics mounted on the drill collar and tuned to excite the formation, along with other configurations.

The illustrated structure of main transmitter 24 ensures the main transmitter 24 is well coupled in a radial direction and is limited to small displacements in an axial direction. This configuration tends to maximize a borehole mode excitation while substantially reducing or eliminating tool arrival. Effectively, the cylindrical piezo component 30 helps achieve these radial and axial effects via the support of spring member 32 and the soft, e.g. elastomeric, material 34. To further minimize the axial direction excitation and thus further reduce tool arrival, the piezo component 30 may be constructed from materials having a small piezoelectric charge constant ratio or from piezo composite materials.

Referring generally to FIG. 4, an enlarged illustration of an embodiment of the canceling source 28 is illustrated. In this example, the canceling source 28 comprises a stack 40 of piezo elements 42, e.g. piezo discs, which may be polarized axially. The stack 40 is placed in rigid attachment with the tool body/collar 36 in the main transmitter 24 direction. On an opposite side of stack 40, a fluid filled cavity 44, e.g. an air cavity, is provided to decouple the stack 40 from the borehole 22. In other embodiments, cancelling source 28 can be composed of other configurations of piezo materials that primarily excite the collar structure.

The construction of the canceling source 28 minimizes the effects of tool arrival on the borehole response to the acoustic signal. The effects are minimized by hydraulically isolating the borehole 22 via an acoustically isolating media, such as the air cavity 44 or other materials with high-acoustic impedance contrast located between the stack 40 and the fluid in borehole 22. By actuating the canceling source 28 solely in the axial direction, the canceling source 28 is further isolated from the borehole 22. Actuation in the axial direction ensures the canceling source 28 is able to cancel the tool arrival effectively, and the arrangement also ensures small displacement in the radial direction to avoid exciting fluids in the borehole 22. It should be noted the canceling source 28 may have other piezo ceramic or piezo composite constructions. In some cases, embodiments of canceling source 28 can have other constructions in which the piezo elements 42 are replaced with electromechanical actuators.

As illustrated, the stack 40 may be rigidly attached to the tool body 36 in the direction of the main transmitter 24 to further improve tool arrival cancellation. To maximize the rigid coupling between the canceling source 28 and the tool body 36, the piezo discs 42 can be glued together or otherwise adhered to each other with suitable high-strength adhesion materials 46, as illustrated in FIG. 5. In some embodiments, the stack 40 may be brazed or otherwise rigidly secured directly to the tool body 36. In active noise cancellation, the firing of the main transmitter 24 and the canceling source 28 is done simultaneously.

A process to perform active noise cancellation includes:
1. Firing the main transmitter 24 only with a known signal and monitoring a response at body 36 from velocity sensors, e.g. accelerometers and pressure sensors, e.g., receivers;
2. Firing the canceling source 28 only with a known signal and monitoring a response at body 36 from velocity sensors, e.g., accelerometers and pressure sensors, e.g., receivers;
3. Using the known firing signals and the measured responses in processes 1 and 2, compute an optimum canceling signal for the canceling source 28;
4. Firing the main source with the known signal from 1 and the canceling source 28 with the computed signal from 3 simultaneously to eliminate the tool arrival at the receivers 26.

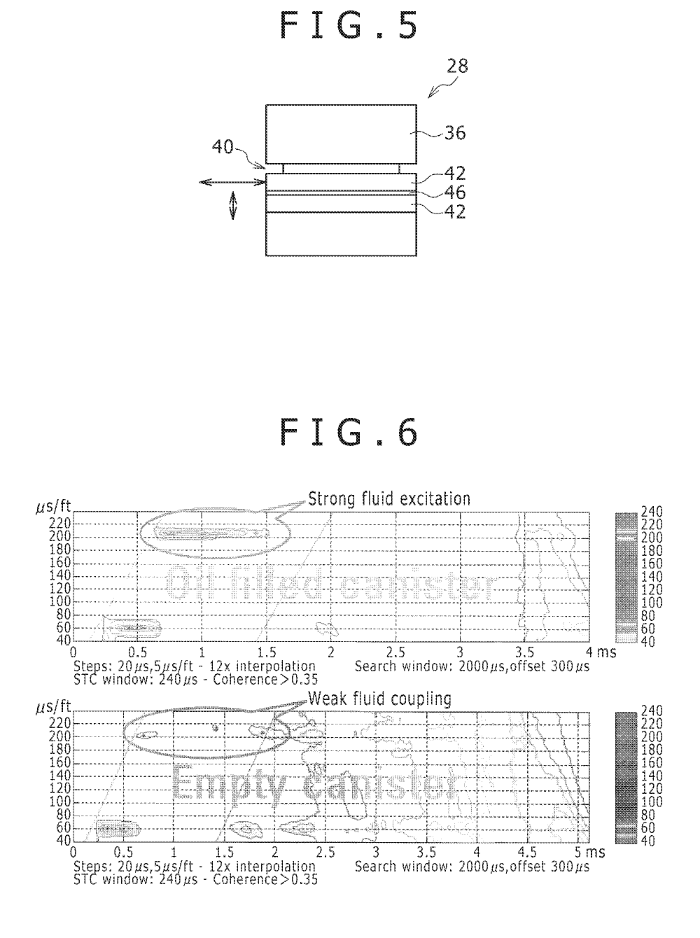

In FIG. 6, a graphical illustration is provided comparing test results associated with testing of the main transmitter 24 and the canceling source 28 in a liquid filled tank. The illustration shows the receiver's slowness-time coherence (STC) results from the main transmitter 24 (see top portion of the graph) and the cancelling source 28 (see bottom portion of the graph). As can be observed from the test results, the main transmitter 24 is coupled to the logging tool 20 from the 60 μs/ft arrival and to the borehole fluid from the 225 μs/ft arrival as expected for sonic tools. However, the test results show the cancelling source 28 does not generate a fluid arrival, thus demonstrating that it is properly isolated from the borehole fluid and accordingly does not significantly affect the borehole sonic signal arrivals.

According to another embodiment, the noise associated with tool arrival may be removed via asynchronous noise cancellation. In this type of embodiment, the tool arrival or tool borne noise is removed from the pressure traces of the acoustic signals by signal processing. As a result, the noise removal is simplified compared to active or physical removal of the noise by, for example, firing a main transmitter and a canceling transmitter simultaneously. Consequently, this approach is able to reduce or eliminate tool arrival without the timing requirements which would otherwise be involved when simultaneously firing a main transmitter and a canceling transmitter during an active noise removal process. This asynchronous noise cancellation approach also avoids the control complexity associated with firing the secondary or canceling transmitter with intricate waveforms. Instead of physically executing step 4 of the previously described active noise cancellation method, the functional results of step 4 are computed or simulated.

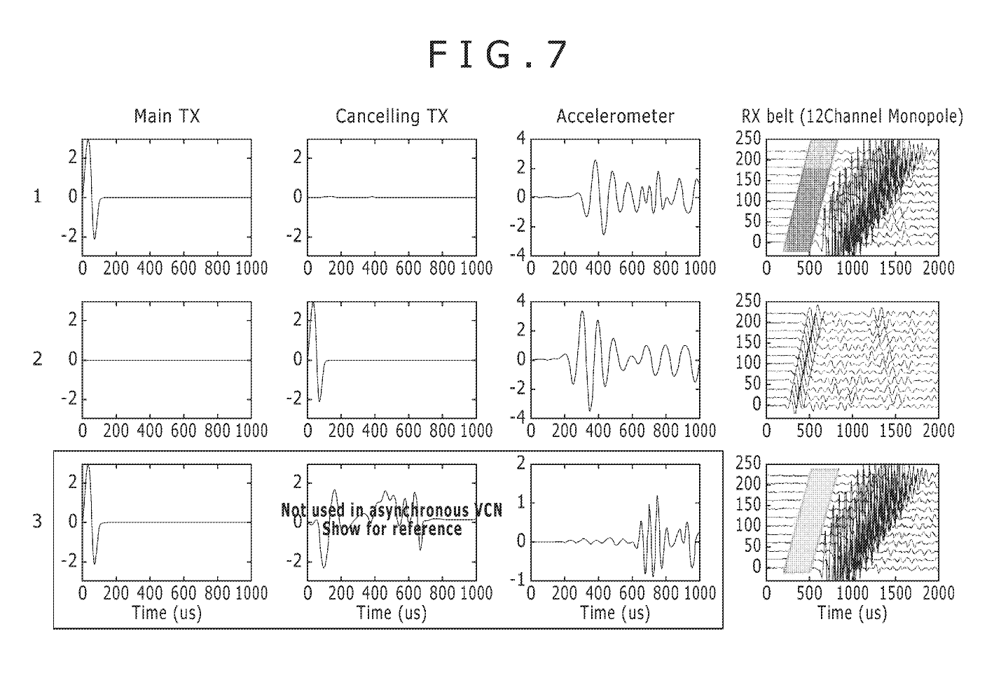

Referring generally to FIG. 7, a graphical illustration is provided to show results of asynchronous noise cancellation (see lower right portion of graph). In this example, the upper portion of the graph illustrates tool arrival/noise which results when a main transmitter is fired with a known signal and the response is measured at the sonic logging tool 20 via velocity sensors, e.g. accelerometers and pressure sensors, e.g., receivers. The middle portion of the graph illustrates tool arrival/noise which results when a calibration transmitter is fired with a known signal and the response is measured at the sonic logging tool via the velocity and pressure sensors. The lower portion of the graph is used to demonstrate the application of asynchronous noise cancellation which effectively removes the tool arrival/noise from the pressure sensor traces, as illustrated in the lower right portion of FIG. 7.

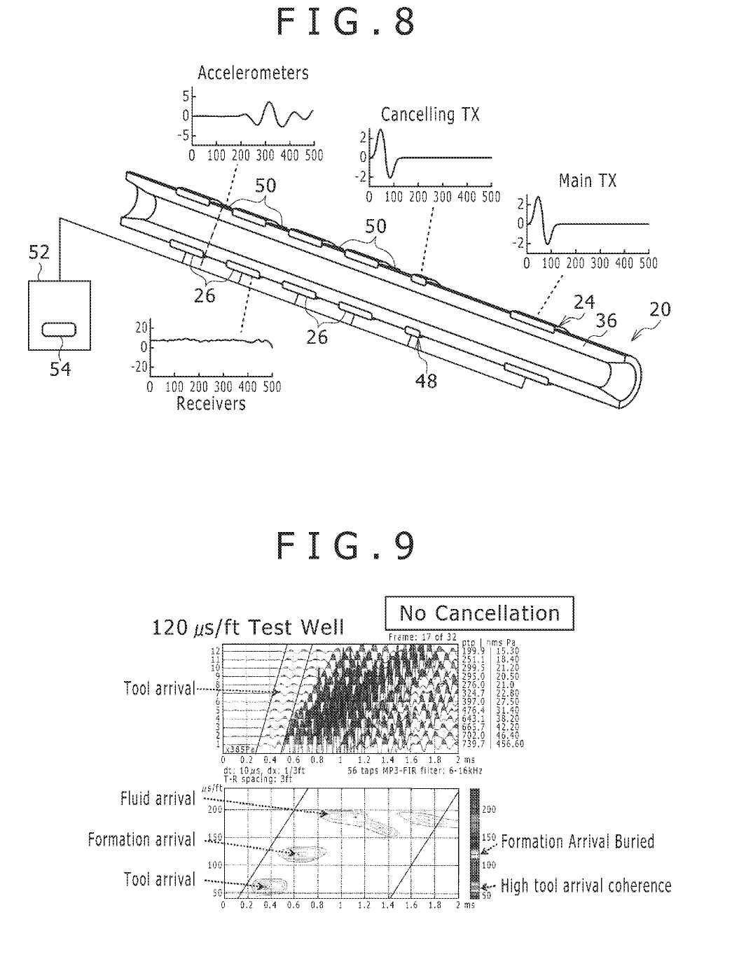

Referring generally to FIG. 8, an embodiment of sonic logging tool 20 which can be used with an asynchronous noise cancellation technique is illustrated. In this example, the sonic logging tool 20 comprises the main transmitter 24 mounted along tool body/collar 36. The main transmitter 24 may be fired to emit an acoustic wave which excites the surrounding geologic formation and also causes excitation of tool body 36. Effectively, the main transmitter 24 is acoustically coupled to the well fluid in borehole 22 surrounding tool 20, to the surrounding formation, and to the tool body 36.

In this example, the sonic logging tool 20 further comprises a calibration transmitter 48, velocity sensors 50, e.g. accelerometers, and acoustic receivers 26. The calibration transmitter 48 may be fired to emit an acoustic wave which is limited to exciting the tool body 36. Accordingly, the calibration transmitter 48 is coupled to the tool body 36 and decoupled from the surrounding well fluid and formation. The accelerometers 50 are positioned to measure tool body acceleration and are thus coupled to the tool body 36 and decoupled from the surrounding well fluid and formation. Thus, the accelerometers 50 are able to directly detect noise associated with tool arrival. The receivers 26 measure acoustic wave pressure resulting from acoustic signals received from the surrounding well fluid and formation as well as from the tool body 36 via coupling of the tool body 36 with the surrounding well fluid.

Data from the various sonic logging tool components, e.g. from the receivers 26 and accelerometers 50, may be provided to a processing system 52, e.g. a computer-based processing system. The processing system 52 may be programmed according to appropriate signal processing methods to remove tool noise from the pressure traces synthetically. By way of example, the processing system 52 may be programmed to employ a conjugated gradient method to remove the tool arrival, e.g. tool noise, from the pressure traces measured by receivers 26. In this embodiment, the processing system 52 is programmed with a suitable algorithm 54, e.g. a conjugated gradient algorithm, which processes the data obtained from the main transmitter 24, calibration transmitter 48, accelerometers 50, and/or receivers 26 in a manner which reduces or removes the noise associated with tool arrival.

In a slightly different embodiment, the processing system 52 may be programmed with algorithm 54 in the form of a filter algorithm to similarly remove the noise associated with tool arrival. The filter may be designed to minimize differences between the accelerometer measurements resulting from the main transmitter 24 and the calibration transmitter 48. By way of example, let s_{M} and s_{C} denote the locations of the main transmitter 24 and calibration transmitter 48, respectively. The corresponding accelerometer measurements may be denoted at location r by A_{M}(t, r, s_{M}) and A_{C}(t, r, s_{C}). In this example, the filter is linear time invariant, depends on transmitter locations, and minimizes

$$H ( t , r , {s}_{M} , {s}_{C} ) = {min}_{h} {‖ h ( . , r ) {*}_{t} {A}_{C} ( . , r , {s}_{C} ) - {A}_{M} ( . , r , {s}_{m} ) ‖}_{2}^{2} + λ {‖ ( . , r ) ‖}_{1}$$

where *ₜ denotes convolution in time and ∥ ∥ₚ denotes Lₚ norm:

[f*ₜg](t)=∫f(τ)g(t−τ)dτ

∥f∥ₚ=(∫|f(t)|^{p}dt)^{1/p}

The L₁ constraint limits the duration of the transmitted waveform resulting in a more compact waveform.

A process to perform asynchronous noise cancellation includes:
1. Firing the main transmitter 24 only with a known signal and monitoring a response at body 36 from velocity sensors, e.g. accelerometers and pressure sensors, e.g., receivers;
2. Firing the calibration transmitter 48 only with a known signal and monitoring a response at body 36 from velocity sensors, e.g., accelerometers and pressure sensors, e.g., receivers;
3. Programming the processing system 52 with a suitable algorithm 54, e.g. a conjugated gradient algorithm or filter algorithm, which processes the data obtained from the main transmitter 24, calibration transmitter 48, accelerometers 50, and/or receivers 26 in a manner which reduces or removes the noise associated with tool arrival.

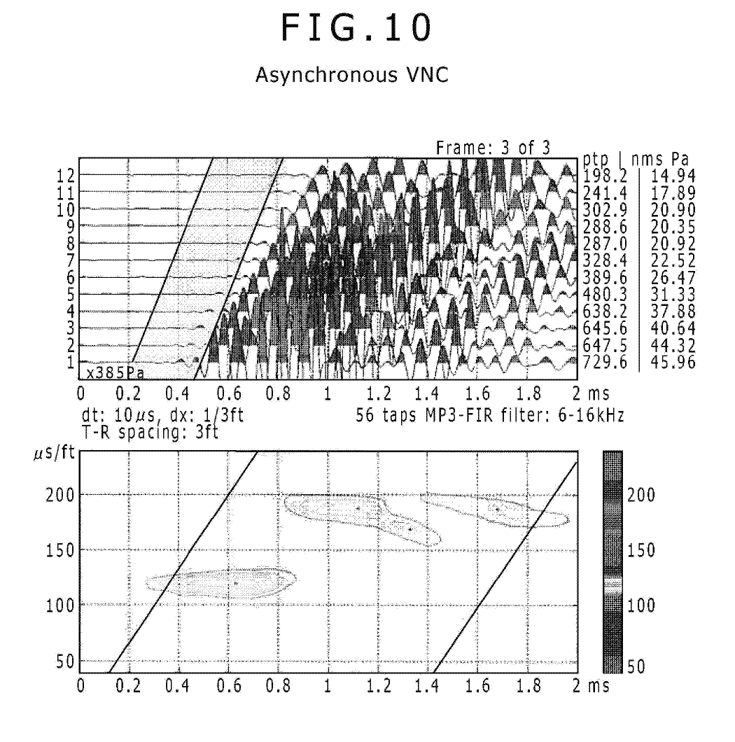

In FIG. 9, a graphical representation is provided of test results obtained from a test well without applying asynchronous noise cancellation. The graphical representation shows time domain pressure traces and slowness-time coherence of the test well and clearly indicates substantial tool arrival which can interfere with the desired acoustic signals from the surrounding formation and well fluid. FIG. 10, however, provides a similar graphical illustration for the same test well once asynchronous noise cancellation has been applied to the collected data by processing system 52. The results achieved may be similar to those achieved with certain active cancellation techniques but with a much simpler, less expensive process. As illustrated, the tool arrival has been substantially reduced by the asynchronous noise cancellation.

Depending on the parameters of a given application and/or environment, the structure of sonic logging tool 20 may comprise a variety of additional and/or other components to facilitate transmission and receipt of the acoustic signal. For example, various arrangements of main transmitters 24, receivers 26, and accelerometers 50 may be placed along the tool body/collar 36. In some applications, the sonic logging tool 20 also may comprise at least one canceling transmitter. Similarly, various types of processing systems 52 may be used to process data at one or more locations, e.g. downhole locations, surface locations and/or remote locations. The processing system 52 may be programmed to carry out the desired algorithms 54 via a variety of software programs and/or models. Additionally, the type and amount of noise canceled may be adjusted according to the parameters of a given application. Also, embodiments disclosed herein may be used individually or in combination.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A method for evaluating a reservoir, comprising:
deploying a sonic logging tool downhole into a borehole;
operating the sonic logging tool to emit and receive acoustic signals from a main transmitter and a cancelling or calibration transmitter;
processing received acoustic signals from the main transmitter and the cancelling or calibration transmitter facilitating removal of tool arrival.

2. The method as recited in claim 1, wherein processing comprises processing the received acoustic signals by processing pressure traces detected by a plurality of acoustic receivers.

3. The method as recited in claim 2, wherein facilitating removal of tool arrival comprises processing the received acoustic signals on a processor system according to an algorithm.

4. The method as recited in claim 3, wherein processing according to the algorithm comprises processing data via a conjugated gradient method.

5. The method as recited in claim 3, wherein processing according to the algorithm comprises processing data via a filter algorithm.

6. The method as recited in claim 1, wherein operating the sonic logging tool to evaluate the reservoir further comprises firing the cancelling or calibration transmitter simultaneously the main transmitter using a waveform determined during facilitating tool arrival removal.

7. The method as recited in claim 1, wherein the cancelling or calibrating transmitter comprises a plurality of radial discs surrounded by a fluid filled cavity.

8. A cancelling transmitter comprising:
a plurality of piezo discs provided in a fluid filled cavity;
wherein the plurality of piezo discs are axially aligned and polarized.

9. The cancelling transmitter in claim 8 wherein the piezo discs are rigidly coupled to a tool body in a direction of a main transmitter.

10. The cancelling transmitter in claim 8 wherein the fluid filled cavity is filled with air.

11. A system to analyze downhole entities, comprising:
a sonic logging tool having:
a tool body;
a plurality of velocity sensors coupled to the tool body and decoupled from a surrounding fluid;
a plurality of acoustic receivers; and
a main transmitter to emit an acoustic wave to excite the formation;
a cancellation or calibration transmitter to emit an axial wave to excite the tool body;
a processor system receiving data from the plurality of velocity sensors and the plurality of acoustic receivers after the main transmitter emits the acoustic wave and the cancellation or calibration transmitter emits the axial wave, the processor system utilizing the data to facilitate removal of tool arrival from the data in order to analyze the downhole entities.

12. The system as recited in claim 11, wherein the main transmitter comprises a cylindrical piezo component resiliently coupled to the tool body.

13. The system as recited in claim 11, wherein the cancellation or calibration transmitter comprises a plurality of piezo discs surrounded by a fluid gap.

14. The system as recited in claim 13 wherein the fluid gap is an air gap.

15. The system as recited in claim 11 wherein the main transmitter is coupled to the surrounding fluid via an oil filled section.

16. The system as recited in claim 11 wherein the sonic tool further comprises a borehole coupling module for the main transmitter.

17. The system as recited in claim 11, wherein the processing system uses the data to compute a waveform for simultaneous transmission by cancellation or calibration transmitter along with the main transmitter.

18. The system as recited in claim 11, wherein the processing system uses the data to determine an algorithm for removing tool arrival from received transmissions from the main transmitter.

19. The system as recited in claim 18 wherein the algorithm is a conjugated gradient algorithm.

20. The system as recited in claim 18 wherein the algorithm is a filter algorithm.
